(19) United States
(12) Patent Application Publication
(10) Pub. No.: US 2008/0170184 A1
(43) Pub. Date: Jul. 17, 2008

(54) POLARIZING PLATE, METHOD OF FABRICATING THE SAME, AND LIQUID CRYSTAL DISPLAY HAVING THE SAME

(75) Inventors: Ho-Yun BYUN, Hwaseong-Si (KR); Duck-Jong SUH, Seoul (KR); Sung Hwan HONG, Suwon-si (KR); Sung-Kyu HONG, Seongnam-si (KR); Nam-Seok LEE, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/962,567

(22) Filed: Dec. 21, 2007

(30) Foreign Application Priority Data
Jan. 15, 2007 (KR) 10-2007-0004337

(51) Int. Cl. G02F 1/1335; B29D 11/00; G02B 5/30

(52) U.S. Cl. 349/97; 359/485; 359/502; 264/1.34; 349/96

(57) ABSTRACT

Disclosed are a polarizing plate, a method of fabricating the polarizing plate, and a liquid crystal display including the polarizing plate. The polarizing plate includes a polarizing film and a supporting film arranged on at least one of an upper surface and a lower surface of the polarizing film. At least one of the polarizing film and the supporting film includes a light absorbing material that partially absorbs the light polarized by the polarizing film. The liquid crystal display includes a liquid crystal panel and the polarizing plate including the light absorbing material. The liquid crystal panel includes first and second substrates facing each other and a liquid crystal layer interposed between the first and second substrates. The polarizing plate is attached to the liquid crystal panel.

### CROSS-REFERENCE TO RELATED APPLICATION

This application claims priority from and the benefit of Korean Patent Application No. 10-2007-0004337, filed on Jan. 15, 2007, which is hereby incorporated by reference for all purposes as if fully set forth herein.

### BACKGROUND OF THE INVENTION

1. Field of the Invention

The present invention relates to a display device. More particularly, the present invention relates to a polarizing plate that may be capable of improving display quality, a liquid crystal display employing the polarizing plate, and a method of fabricating the polarizing plate.

2. Discussion of the Background

In general, a liquid crystal display uses liquid crystals and changes an electrical signal into an image signal to display an image. The liquid crystal display includes a liquid crystal panel including liquid crystals and a polarizing plate. The polarizing plate includes an upper polarizing plate attached to an upper portion of the liquid crystal panel and a lower polarizing plate attached to a lower portion of the liquid crystal panel. The polarizing plate polarizes light, and the polarized direction of light by the upper polarizing plate is substantially perpendicular to the polarized direction of light by the lower polarizing plate. Therefore, light polarized by the lower polarizing plate is absorbed by the upper polarizing plate, so the liquid crystal display is in a black state.

Meanwhile, the alignment of the liquid crystals may cause a phase shift for light passing through the liquid crystal panel. When the phase of light passing through the liquid crystal panel shifts, the light passes through the upper polarizing plate and the liquid crystal display is in a white state that is brighter than the black state.

However, even when the liquid crystal panel is in the black state, the phase of the light may be partially shifted when the light passes through the liquid crystal panel. Since the phase shifted light passes through the upper polarizing plate, the liquid crystal display may emit light even when the liquid crystal display is in the black state. As a result, the brightness difference between the black state and the white state is decreased, thereby deteriorating the image quality of the liquid crystal display.

### SUMMARY OF THE INVENTION

The present invention provides a polarizing plate that may enable a display device to display a high quality image.

The present invention also provides a method of fabricating the polarizing plate.

The present invention also provides a liquid crystal display including the polarizing plate.

Additional features of the invention will be set forth in the description which follows, and in part will be apparent from the description, or may be learned by practice of the invention.

The present invention discloses a polarizing plate including a polarizing film and a supporting film. The polarizing film includes a polarizing material that polarizes light. The supporting film is arranged on at least one of an upper surface and a lower surface of the polarizing film. At least one of the polarizing film and the supporting film includes a light absorbing material that partially absorbs the light polarized by the polarizing film, and the absorbed light has a wavelength corresponding to visible light.

The present invention also discloses a method of fabricating a polarizing plate. An optical film is elongated to form a polarizing film that polarizes a light in a direction substantially perpendicular to the direction in which the optical film is elongated. Then, a supporting film is formed on at least one of an upper surface and a lower surface of the polarizing film. At least one of the polarizing film and the supporting film has a light absorbing material that partially absorbs light polarized by the polarizing film. The absorbed light has a wavelength corresponding to visible light.

The present invention also discloses a liquid crystal display including a liquid crystal panel, a polarizing plate, and an adhesive layer. The liquid crystal panel includes a first substrate and a second substrate facing each other and a liquid crystal layer interposed between the first substrate and the second substrate. The polarizing plate is attached to the liquid crystal panel to polarize a light. The adhesive layer is interposed between the liquid crystal panel and the polarizing plate to attach the polarizing plate to the liquid crystal panel. The polarizing plate includes a first polarizing plate attached to the first substrate and a second polarizing plate attached to the second substrate, and at least one of the adhesive layer, the first polarizing plate, and the second polarizing plate includes a light absorbing material that partially absorbs light polarized by the polarizing plate. The absorbed light has a wavelength corresponding to visible light.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view showing a liquid crystal display according to an exemplary embodiment of the present invention.

FIG. 2 is an exploded perspective view showing the liquid crystal panel shown in FIG. 1.

FIG. 3A and FIG. 3B are cross-sectional views showing the operation of the liquid crystal display of FIG. 1.

FIG. 4 is a view showing the polarization of light when the liquid crystal display of FIG. 1 is in a black state.

FIG. 5A, FIG. 5B, FIG. 5C, and FIG. 5D are cross-sectional views showing various exemplary embodiments of polarizing plates used for the liquid crystal display of FIG. 1.

FIG. 6A, FIG. 6B, and FIG. 6C are graphs showing the change in light transmittance according to wavelength with respect to various liquid crystal displays.

FIG. 7A, FIG. 7B, FIG. 7C, and FIG. 7D are views showing a method of fabricating a polarizing plate according to an exemplary embodiment of the present invention.

FIG. 8A, FIG. 8B, FIG. 8C, and FIG. 8D are views showing a method of fabricating a polarizing plate according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

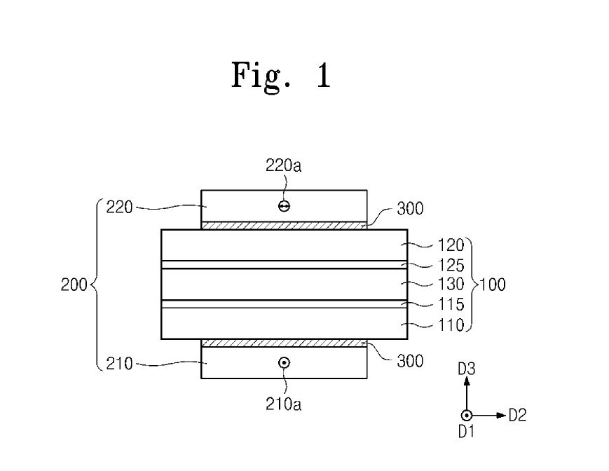

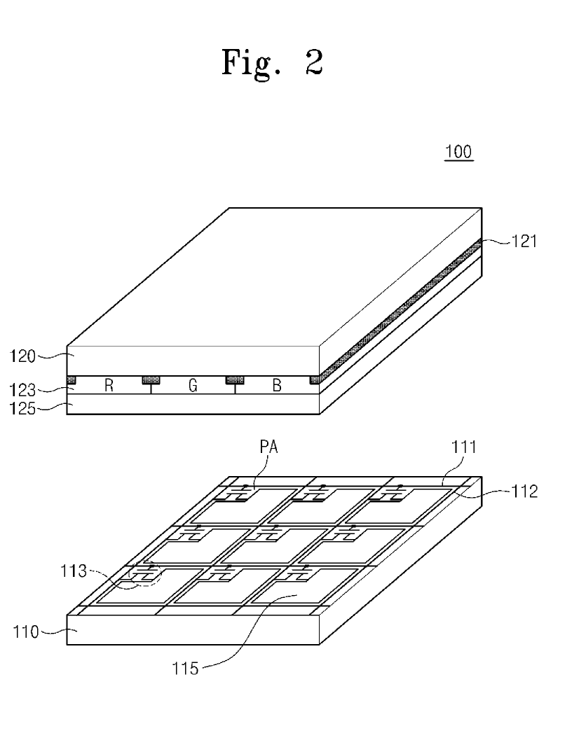

FIG. 1 is a cross-sectional view showing a liquid crystal display according to an exemplary embodiment of the present invention.

Referring to FIG. 1, the liquid crystal display includes a liquid crystal panel 100 and a polarizing plate 200. The liquid crystal panel 100 includes two substrates facing each other. Hereinafter, in order to distinguish the two substrates from each other, a substrate positioned in a lower position is referred to as a first substrate 110 and a substrate positioned in an upper position is referred to as a second substrate 120. The first substrate 110 includes a pixel electrode 115 formed thereon and the second substrate 120 includes a common electrode 125 formed thereon. Pixel areas are defined on the first substrate 110 to display an image thereon. The pixel electrode 115 is positioned in each pixel area. The common electrode 125 may cover the whole surface of the second substrate 120 in the display region. The liquid crystal panel 100 includes a liquid crystal layer 130 interposed between the pixel electrode 115 and the common electrode 125.

The polarizing plate 200 is attached to an external surface of the liquid crystal panel 100. The polarizing plate 200 includes a first polarizing plate 210 and a second polarizing plate 220. The first polarizing plate 210 is attached to an external surface of the first substrate 110 and the second polarizing plate 220 is attached to an external surface of the second substrate 120. The first polarizing plate 210 has a first transmission axis 210a along a first direction D1. The second polarizing plate 220 has a second transmission axis 220a along a second direction D2.

An adhesive layer 300 is interposed between the liquid crystal panel 100 and the polarizing plate 200. The adhesive layer 300 couples the first and second polarizing plates 210 and 220 with the first and second substrates 110 and 120, respectively. The liquid crystal panel 100 and the polarizing plate 200 may be detached from each other, if necessary. For example, if an operational error occurs when the polarizing plate 200 is attached to the liquid crystal panel 100, the polarizing plate 200 may be detached from the liquid crystal panel 100 and the detached liquid crystal panel 100 may be reused.

FIG. 2 is an exploded perspective view showing the liquid crystal panel shown in FIG. 1.

Referring to FIG. 2, the first substrate 110 includes a plurality of gate lines 111 and a plurality of data lines 112. The gate lines 111 and the data lines 112 are insulated from each other and cross each other to define pixel areas PA. A thin film transistor 113 and a pixel electrode 115 are provided in each pixel area PA. Each thin film transistor 113 includes a control electrode connected to the corresponding gate line 111, an input electrode connected to the corresponding data line 112, and an output electrode facing the input electrode. Each pixel electrode 115 is connected to the corresponding output electrode.

The second substrate 120 includes a light blocking layer pattern 121 and a color filter 123. The light blocking layer pattern 121 includes openings corresponding to each pixel area PA. The color filter 123 is formed on the light blocking layer pattern 121 and fills the openings of the light blocking layer pattern 121. The color filter 123 includes a red color filter R, a green color filter G, and a blue color filter B. The red color filter R, the green color filter G, and the blue color filter B are sequentially arranged according to the pixel areas PA. The liquid crystal display uses combinations of the three color filters R, G, and B to display an image with various colors. A common electrode 125 is formed over the color filter 123.

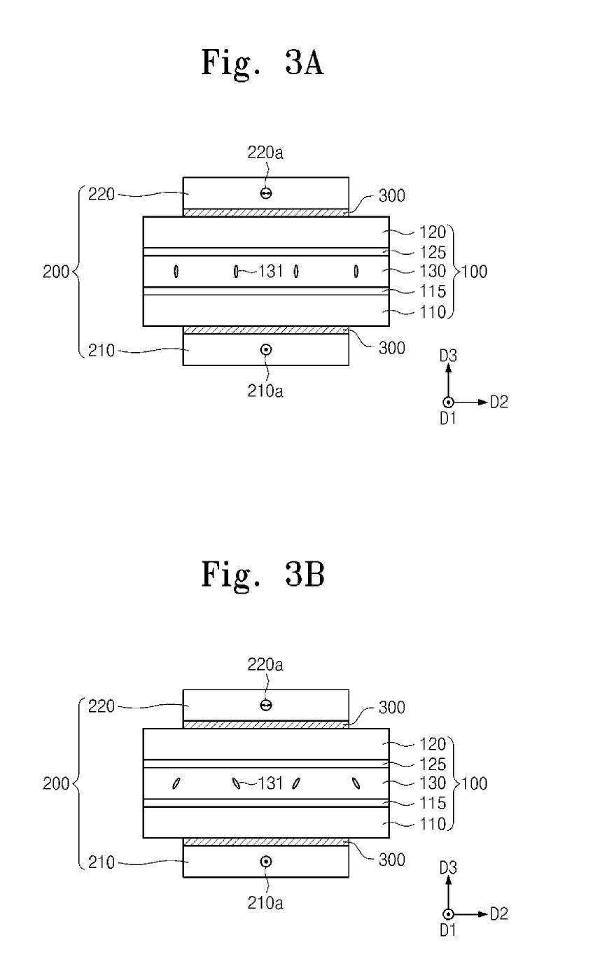

FIG. 3A and FIG. 3B are cross-sectional views showing an operation of the liquid crystal display of FIG. 1.

Referring to FIG. 2 and FIG. 3A, the liquid crystal display operates in two different states according to whether or not an electric field is being applied to the liquid crystal layer 130. When the electric field is not applied to the liquid crystal layer 130, liquid crystals 131 of the liquid crystal layer 130 are aligned in a direction substantially perpendicular to the first and second substrates 110 and 120. The liquid crystals 131 have an oval shape with a long-axis and a short-axis, and the alignment of the liquid crystals 131 is defined by the direction of the long-axis.

Since the liquid crystals 131 are not self-emissive, the liquid crystal display requires a separate light source to display an image. The liquid crystal display may employ a backlight unit having a self-emissive element, such as a light emitting diode, as the light source. Otherwise, in lieu of light generated by a backlight unit, the liquid crystal display may use light from the outside that is incident on the liquid crystal display as the light source. In this case, the liquid crystal display reflects the incident light to display an image.

When using a backlight unit as the light source, the liquid crystal display operates as follows. The backlight unit is arranged under the first polarizing plate 210 to generate the light. The light generated by the backlight unit travels in a third direction D3 and passes through the first polarizing plate 210 to be linearly polarized in the first direction D1. The linearly polarized light passes through the liquid crystal layer 130 and enters the second polarizing plate 220. The first and second polarizing plates 210 and 220 are disposed so that their transmission axes are substantially perpendicular to each other. Therefore, the linearly polarized light is absorbed by the second polarizing plate 220 and the liquid crystal display is in a black state.

Referring to FIG. 2 and FIG. 3B, a gate signal and a data signal are transmitted through the gate line 111 and the data line 112, respectively. The gate signal allows the thin film transistor 113 to turn on, so that a data voltage corresponding to the data signal is applied to the pixel electrode 115 through the data line 112. In addition, a constant common voltage is applied to the common electrode 125. Due to the voltage difference between the data voltage and the common voltage, an electric field is established between the first and second substrates 110 and 120. In response to the electric field, the liquid crystals 131 are aligned in an inclined direction with respect to the first and second substrates 110 and 120.

While the liquid crystals 131 are in this alignment state, the light provided by the backlight unit passes through the first polarizing plate 210 to be linearly polarized in the first direction D1. While the linearly polarized light passes through the liquid crystal layer 130, the phase of the light is shifted due to the inclination of the liquid crystals 131. Since the phase shifted light is substantially parallel to the second direction D2, the phase shifted light may pass through the second polarizing plate 220, causing the liquid crystal display to be in a white state that is brighter than the black state. At this operation, the intensity of the light parallel to the second direction D2 varies according to the inclination of the liquid crystals 131, and the inclination of the liquid crystals 131 is adjusted by controlling the intensity of the electric field.

The liquid crystal display's image quality depends on its contrast ratio, which relates to the brightness difference between the black state and the white state. An increased contrast ratio permits display of a higher quality image. Two methods for increasing contrast ratio are discussed below. One method increases the brightness of the light when the liquid crystal display is in the white state, and the other method decreases the brightness when the liquid crystal display is in the black state. As described below, the liquid crystal display according to the present exemplary embodiment decreases the brightness of the black state to provide a high quality image.

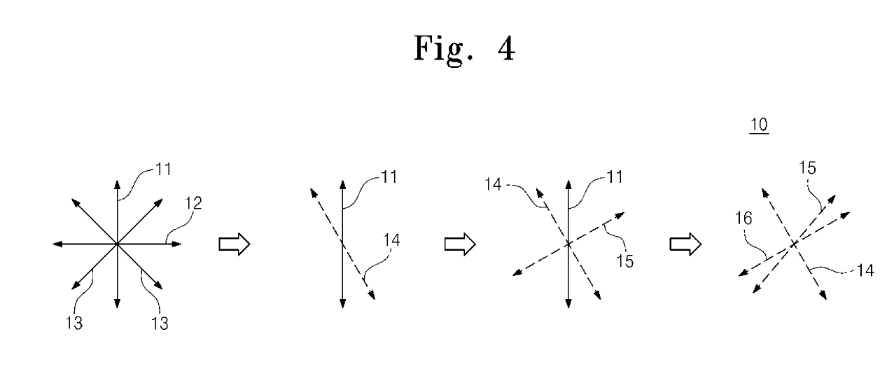

FIG. 4 is a view showing an operation of polarizing the light when the liquid crystal display of FIG. 1 is in the black state.

Referring to FIG. 4, light that is not polarized includes various components, each of which corresponds to a predetermined direction. Hereinafter, for convenience of explanation, the various components are referred to as a first light component 11, a second light component 12, and a third light component 13. The first and second light components 11 and 12 correspond to the first and second transmission axes 210a and 220a of the first and second polarizing plates 210 and 220, respectively. That is, the first light component 11 is substantially parallel to the first direction D1 and the second light component 12 is substantially parallel to the second direction D2. The third light component 13 includes all other components.

Generally, the unpolarized light 10 is linearly polarized while passing through the first polarizing plate 210. That is, the second and third light components 12 and 13 of the light 10 are absorbed by the first polarizing plate 210 and only the first light component 11 is linearly polarized. However, linearly polarized light may include another light component other than the first light component 11. For example, if the first transmission axis 210a is not uniformly formed along the first direction D1 when the first polarizing plate 210 is fabricated, a separate light component may be generated. Hereinafter, the separate light component is referred to as a fourth light component 14.

When the linearly polarized light 10 passes through the liquid crystal panel 100, the light 10 may further include another separate light component other than the first and fourth light components 11 and 14. Hereinafter, another separate light component is referred to as a fifth light component 15. The fifth light component 15 may be generated due to various reasons related to the liquid crystal layer 130 and the color filter 123.

Most of the liquid crystals 131 in the liquid crystal layer 130 are aligned in a direction perpendicular to the first and second substrates 110 and 120. However, if the first and second substrates 110 and 120 have an uneven surface, some of the liquid crystals 131 may be inclined with respect to the first and second substrates 110 and 120 in regions corresponding to the uneven surface. In this case, the phase of the light 10 passing through the liquid crystal layer 130 may be shifted, causing the light 10 to have a separate light component in addition to the first component 11.

The color filter 123 may scatter the light 10 passing therethrough. This scattering is caused by a pigment included in the color filter 123. That is, since the pigment includes particles having a size corresponding to a wavelength of the light 10, the light 10 is scattered by the particles, so that the light 10 may include a separate light component in addition to the first component 11.

Therefore, the light 10 passing through the liquid crystal panel 100 may further include the fourth and fifth light components 14 and 15 in addition to the first light component 11. In addition, while light 10 passes through the second polarizing plate 220, a sixth light component 16 may be generated for the same reason the fourth light component 14 may be generated by the first polarizing plate 210. The first light component 11 is absorbed by the second polarizing plate 220 but the fourth, fifth, and sixth light components 14, 15, and 16 are not absorbed by the second polarizing plate 220. As a result, the brightness of the black state may be increased and the contrast ratio may be decreased, thereby degrading the image quality.

According to the present exemplary embodiment, the liquid crystal display may include a light absorbing material that can absorb the fourth, fifth, and sixth light components 14, 15, and 16. The absorbing material prevents the fourth, fifth, and sixth light components 14, 15, and 16 from being emitted outwardly, so that the brightness of the black state may be decreased.

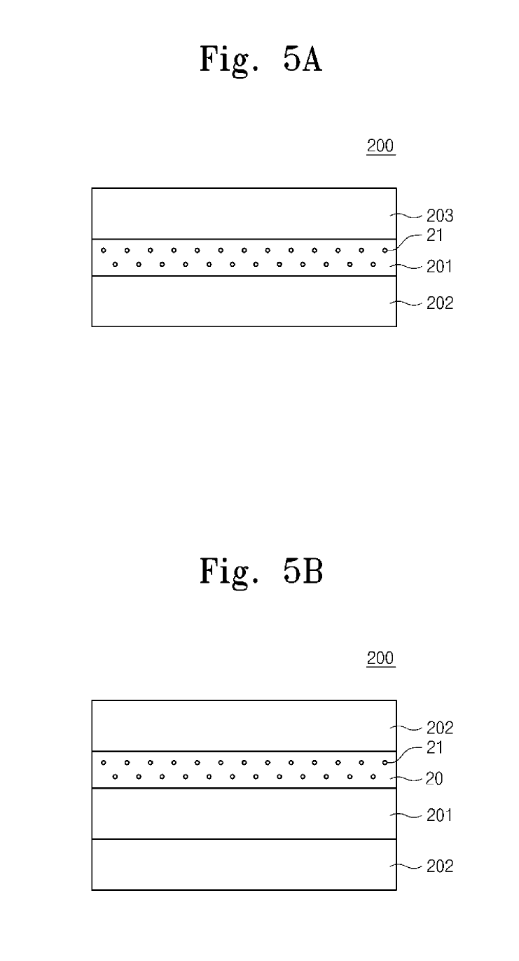

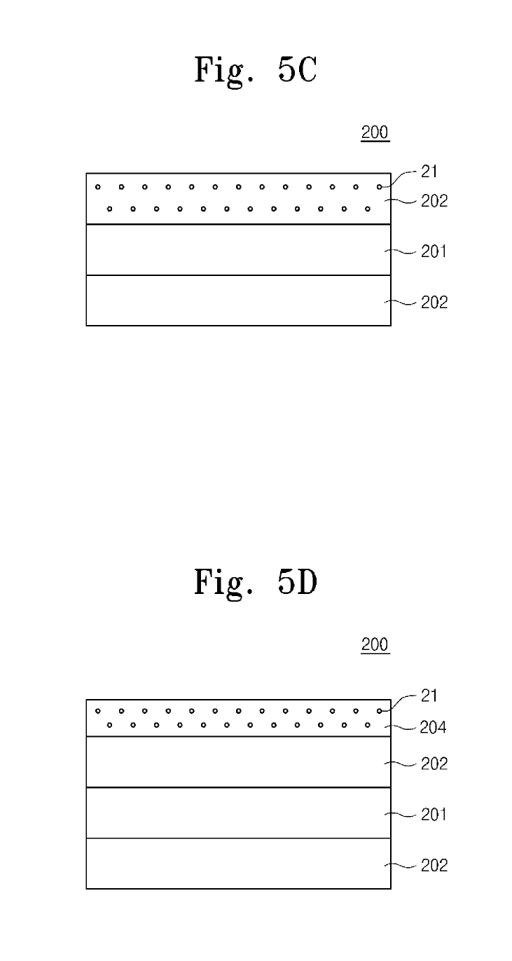

The light absorbing material may be provided in any part of the liquid crystal display. For example, the light absorbing material may be provided in the polarizing plate 200 or the adhesive layer 300 between the liquid crystal panel 100 and the polarizing plate 200. Hereinafter, various exemplary embodiments in which the light absorbing material is provided in the polarizing plate 200 will be described with reference to FIG. 5A, FIG. 5B, FIG. 5C, and FIG. 5D.

FIG. 5A, FIG. 5B, FIG. 5C, and FIG. 5D are cross-sectional views showing various exemplary embodiments of the polarizing plates for the liquid crystal display of FIG. 1.

Referring to FIG. 5A, the polarizing plate 200 includes a polarizing film 201, a supporting film 202, and a compensating film 203. The polarizing film 201 polarizes light and includes a polyvinyl alcohol compound. The polarizing film 201 may be formed by allowing an optical film including the polyvinyl alcohol compound to adsorb iodine (I) or dichroic dye and elongating the optical film in a predetermined direction. The transmission axis of the polarizing film 201 is defined along a direction substantially perpendicular to the direction in which the optical film is elongated. As described above, if the optical film is not uniformly elongated along the predetermined direction, light passing through the polarizing plate 200 may further include light components that are not parallel to the transmission axis of the polarizing film 201.

The polarizing film 201 includes a light absorbing material 21. The light absorbing material 21 is dispersed in the polarizing film 201 to absorb light passing through the polarizing film 201 over the whole area of the polarizing film 201. As a result, light leaked from the liquid crystal panel 100 and the polarizing plate 200 may be blocked, so the brightness of the black state of the liquid crystal display may be decreased.

The light absorbing material 21 may absorb light having a wavelength within a predetermined absorption range. Since the liquid crystal display uses visible light to display an image, the absorption range may correspond to that of visible light. For example, if visible light has a wavelength from 360 to 750 nanometers, the light absorbing material 21 may entirely or partially absorb light having a wavelength from 360 to 750 nanometers.

If the brightness of the black state increases because light leaked from the liquid crystal display mainly includes a specific color component, light absorbing material 21 suitable for absorbing light of the specific color may be applied to the liquid crystal display. For example, if green light is leaked, light absorbing material 21 suitable for absorbing green light having a wavelength from 450 to 600 nanometers may be applied. Similarly, if red light, green light, and blue light are leaked, three light absorbing materials respectively suitable for absorbing the three colors of light may be applied.

The light absorbing material 21 may include a compound represented by the chemical formula of (SO₃M)ₙ. In the chemical formula, ‘M’ indicates a positive ion and ‘n’ indicates a positive integer. The compound represented by the chemical formula of (SO₃M)ₙ may include a first compound represented by the following chemical formula 1. The first compound mainly absorbs blue light.

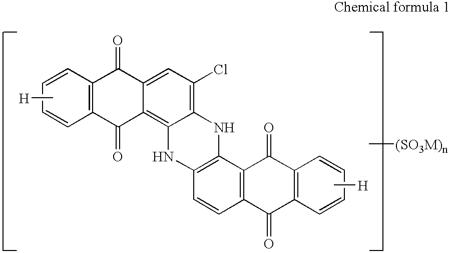

The compound represented by the chemical formula of (SO₃M)ₙ may include a second compound represented by the following chemical formula 2. The second compound mainly absorbs red light.

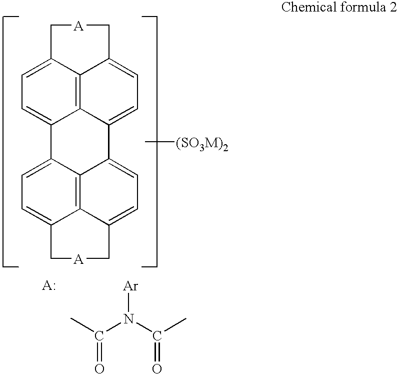

The compound represented by the chemical formula of (SO₃M)ₙ may include a third compound represented by the following chemical formula 3. The third compound mainly absorbs yellow light.

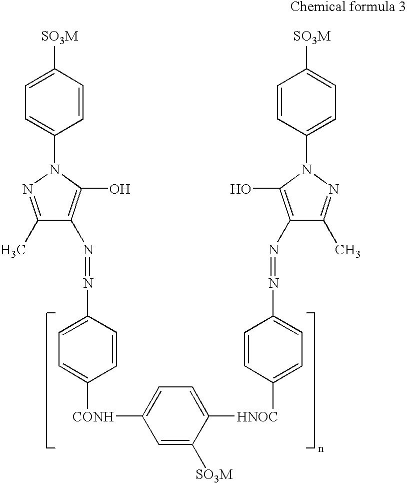

In addition to the first, second, and third compounds, there may be other compounds represented by the chemical formula of (SO₃M)ₙ, each of which may absorb a light having various wavelengths corresponding to various colors. The light absorbing material 21 may include one or more of the compounds represented by the chemical formula of (SO₃M)ₙ to absorb light having various wavelengths. For example, if the light absorbing material 21 may include a compound in which the first compound compounded with the third compound, the compound may absorb green light. If the light absorbing material 21 includes a compound capable of absorbing red, green, and blue light, the light absorbing material 21 may absorb all visible light.

The light absorbing material 21 is not confined to a compound represented by the chemical formula of (SO₃M)ₙ. For example, the light absorbing material 21 may include methylene blue to absorb blue light.

Meanwhile, the light absorbing material 21 may include a single material capable of absorbing any color of light having a wavelength corresponding to visible light. For example, if the light absorbing material 21 includes a black material, the light absorbing material 21 may absorb any color of light. In this case, a black conductor may be used as the black material.

For example, a black conductor used as the light absorbing material 21 may include one material selected from the group of carbon black, carbon nanotubes, and fullerene. Otherwise, the black conductor may include at least two materials selected from the group. The carbon black includes minute particles and may be treated in order to be conductive. A carbon nanotube has a structure in which hexagons composed of six carbon atoms are connected to each other in a tube shape. The tube has a diameter of a few nanometers to dozens of nanometers and has conductivity similar to that of copper. The fullerene indicates a molecule where pentagons and hexagons composed of carbon atoms are connected with each other in a ball shape. The fullerene is generally used as a cluster where sixty carbon atoms (C₆₀) are combined with each other in a soccer ball shape. A metal may be introduced in the fullerene to make it conductive.

Meanwhile, a black conductor used as the light absorbing material 21 may include a polymer compound. For example, the black conductor may include a conductive polymer including at least one of polythiophene, polypyrrole, and polyethylenedioxythiophene. The conductive polymer includes a carbon chain with a plurality of carbon atoms having single bonds and covalent bonds between the carbon atoms. The carbon chain provides a tunnel through which carriers, such as an electron, may move, so that the polymer may be conductive. Also, the conductive polymer may include dopants in order to control the concentration of the carriers included therein.

There are various other black materials that are also capable of absorbing visible light and may be used as the light absorbing material 21. These black materials are not required to be conductive. However, if the light absorbing material 21 is conductive, it may be possible to prevent static electricity and improve image quality.

Static electricity may be generated due to various reasons while fabricating the liquid crystal display. For example, when the liquid crystal panel 100 is transferred by a transfer unit, static electricity may be generated due to contact between the liquid crystal panel 100 and the transfer unit. In addition, when the polarizing plate 200 is attached to the liquid crystal panel 100, static electricity may be generated due to friction between the liquid crystal panel 100 and the polarizing plate 200. If static electricity remains in the liquid crystal panel 100, the liquid crystal display may malfunction. According to the present exemplary embodiment, the conductive light absorbing material 210 is dispersed in the polarizing film 201, so the polarizing film 201 serves as a conductive layer. The conductive layer prevents static electricity from inflowing into the liquid crystal panel 100 and removes static electricity generated inside the liquid crystal panel 100.

The supporting film 202 supports the polarizing film 201. The supporting film 202 may be durable to protect the mechanical strength, heat-resisting property, and humidity-resisting property of the polarizing film 201. The supporting film 202 may not have any optical effect on the light passing therethrough. As an example of the present exemplary embodiment, the supporting film 202 may include Cellulose Tri-Acetate.

The polarizing film 201 is interposed between the supporting film 202 and the compensating film 203. The compensating film 203 plays two different roles.

First, the compensating film 203 compensates the phase shift of light passing through the liquid crystal panel 100 in a lateral direction, which may improve image quality in the lateral direction and widen the viewing angle of the liquid crystal display. The compensating film 203 is provided together with at least one polarizing plate of the first and second polarizing plates 210 and 220. The compensating film 203 may be removed from the polarizing plate 200.

Second, the compensating film 203 provides additional support to the polarizing film 201 together with the supporting film 202. Therefore, instead of using the compensating film 203 as an auxiliary supporting film, the supporting film 202 may include two films supporting upper and lower surfaces of the polarizing film 201, respectively.

Referring to FIG. 5B, the polarizing plate 200 includes a polarizing film 201, a supporting film 202, and a light absorbing layer 20. The polarizing film 201 polarizes light. The supporting film 202 includes two films opposite each other that support the polarizing film 201, which is interposed between the two films. The light absorbing layer 20 includes a light absorbing material 21 therein and is formed as an optical film separate from the polarizing film 201 and the supporting film 202. The light absorbing layer 20 may be interposed between the polarizing film 201 and the supporting film 202. Although not shown in FIG. 5B, the light absorbing layer 20 may be attached to an upper surface or a lower surface of at least one of the two films making up the supporting film 202.

Referring to FIG. 5C, the polarizing plate 200 includes a polarizing film 201 and a supporting film 202. The polarizing film 201 polarizes light. The supporting film 202 includes two films opposite each other that support the polarizing film 201, which is interposed between the two films. The supporting film 202 may include a light absorbing material 21 dispersed therein.

Referring to FIG. 5D, the polarizing plate 200 includes a polarizing film 201, a supporting film 202, and a surface treatment film 204. The polarizing film 201 polarizes light. The supporting film 202 includes two films opposite each other that support the polarizing film 201, which is interposed between the two films. A surface treatment film 204 may be formed on one of the two films and positioned at an outermost position when used in the liquid crystal display.

More specifically, the surface treatment film 204 may be arranged on a top of the second polarizing plate 220 (refer to FIG. 1) to protect the second polarizing plate 220 from external impacts. In addition, the surface treatment film 204 may be treated to have anti-static and/or anti-glare properties to prevent static electricity in the liquid crystal display and diffused reflection of light incident into the liquid crystal display, which may improve the image quality.

The surface treatment film 204 includes a light absorbing material 21 dispersed therein. If the light absorbing material 21 is conductive, the surface treatment film 204 is not necessary to provide an anti-static property.

As described in the above exemplary embodiments with reference to FIG. 5A, FIG. 5B, FIG. 5C, and FIG. 5D, the light absorbing material 21 may not be provided with specific films constituting the polarizing plate 200. In other words, the light absorbing material 21 may be dispersed in each film of the polarizing plate 200, or provided with a separate optical film in which the light absorbing material 21 is dispersed. In addition, the light absorbing material 21 may be dispersed in the adhesive layer 300 that couples the polarizing plate 200 to the liquid crystal panel 100.

When considering the traveling path of the light, it may be advantageous for the light absorbing material 21 to be formed in at least the second polarizing plate 220 of the first and second polarizing plates 210 and 220. This is because, if the light absorbing material 21 is formed only in the first polarizing plate 210, light leakage generated by the second polarizing plate 220 may not be absorbed. However, if the light absorbing material 21 is formed in the second polarizing plate 220, light leakage generated by both the first and second polarizing plates 210 and 220 may be absorbed.

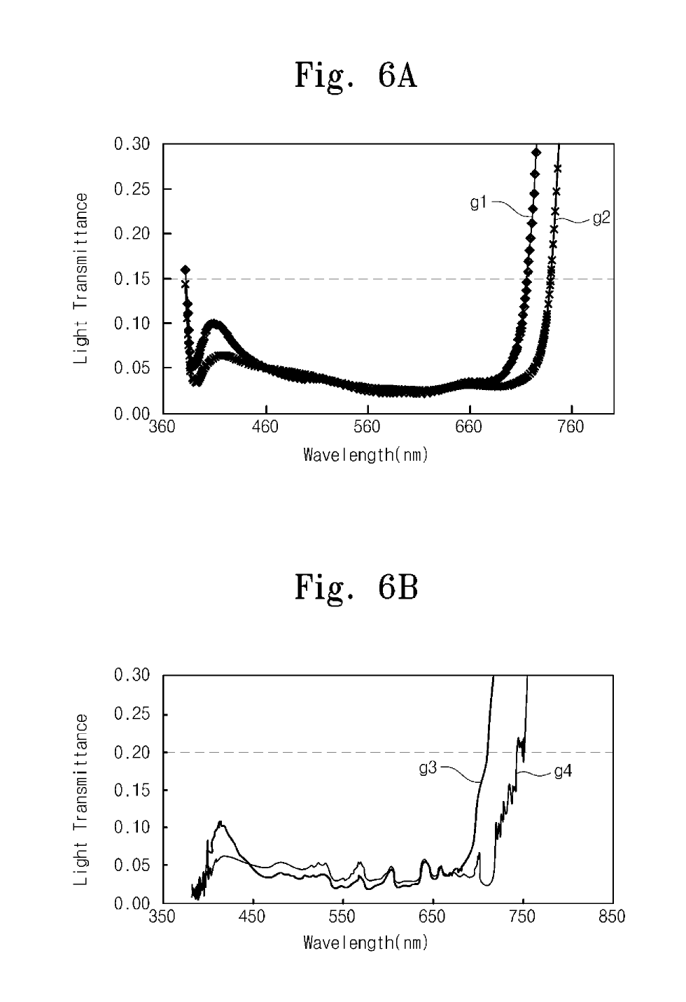

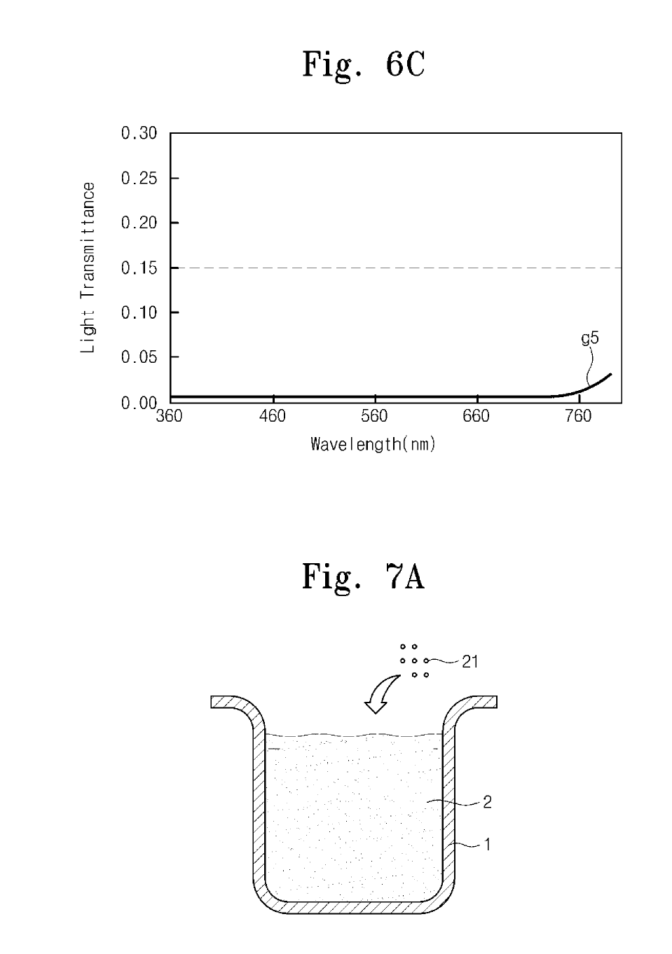

FIG. 6A, FIG. 6B, and FIG. 6C are graphs showing the change in light transmittance according to wavelength with respect to various liquid crystal displays.

FIG. 6A shows experimental results of two different samples g1 and g2 selected from conventional liquid crystal displays. In FIG. 6A, the y axis indicates the light transmittance measured from a vertical direction of each sample when the liquid crystal panel is removed from each sample. In addition, two polarizing plates of each sample are disposed such that their transmission axes are substantially perpendicular to each other.

Referring to FIG. 6A, each sample has low light transmittance with respect to a wavelength corresponding to the visible light. However, the light transmittance of each sample significantly increases at wavelengths of approximately 380 nanometers and 700 nanometers due to light leakage from the two polarizing plates.

FIG. 6B shows experimental results of two different samples g3 and g4 selected from conventional liquid crystal displays. In FIG. 6B, the light transmittance is measured when each sample is provided with a liquid crystal panel. In addition, two polarizing plates of each sample are disposed such that their transmission axes are substantially perpendicular to each other.

Referring to FIG. 6B, each sample has a low light transmittance with respect to a wavelength corresponding to visible light, and the light transmittance slightly fluctuates. However, the light transmittance of each sample significantly increases at wavelengths of approximately 380 nanometers and 700 nanometers due to the light leakage from the two polarizing plates and the liquid crystal panel.

FIG. 6C shows experimental results of a sample g5 selected from liquid crystal displays according to the present invention. In FIG. 6C, light transmittance is measured when a liquid crystal panel is removed from the selected sample. In addition, two polarizing plates of the selected sample are disposed such that their transmission axes are substantially perpendicular to each other.

Referring to FIG. 6C, the light transmittance of the sample is approximately zero at wavelengths corresponding to visible light. This means that there may be substantially no light leakage from the polarizing plates. Considering the experimental results shown in FIG. 6A, FIG. 6B, and FIG. 6C, the light absorbing material may block the light leakage, so the image quality of the liquid crystal display may be improved.

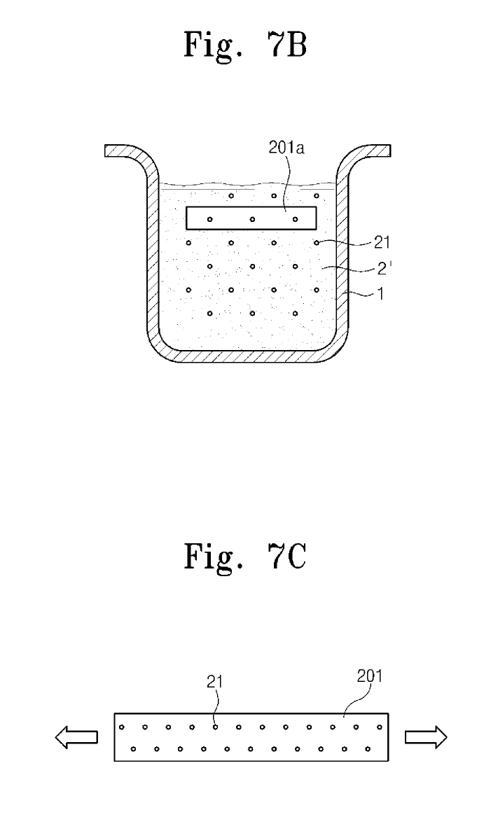

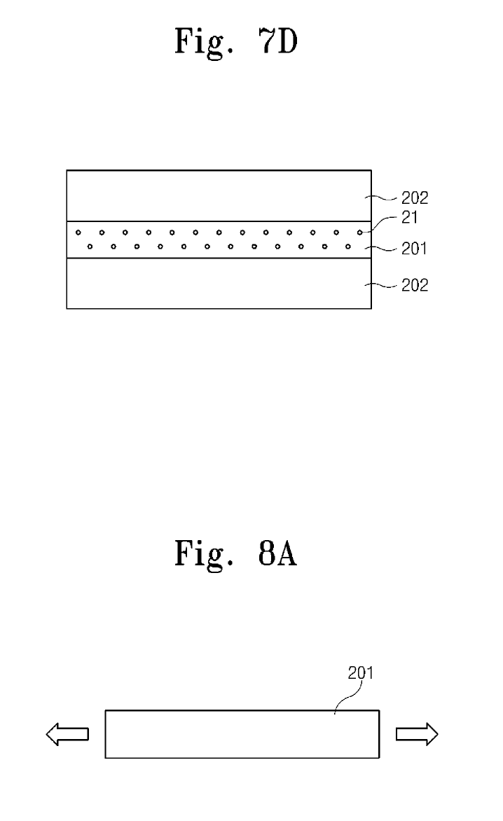

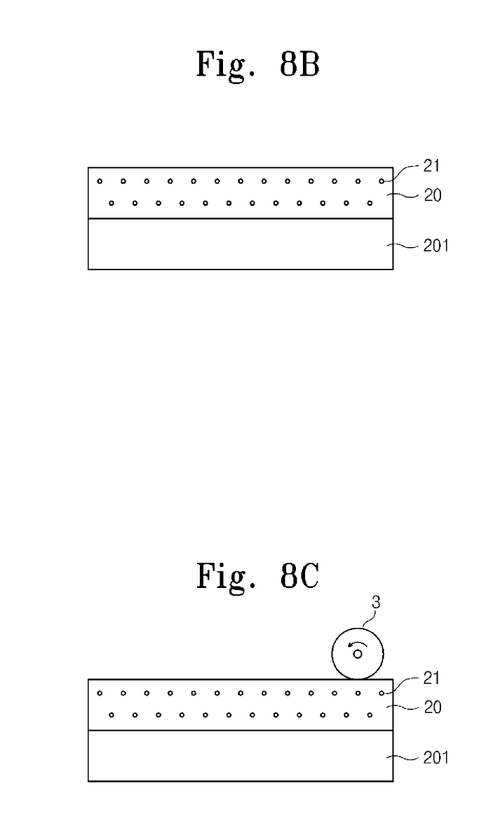

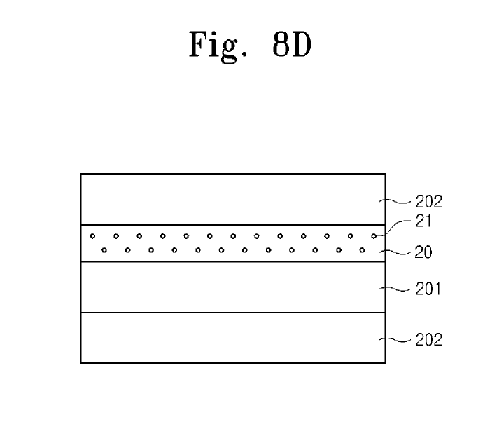

The polarizing plate having the light absorbing material, as described above, may be fabricated in various methods. Hereinafter, two methods for fabricating the polarizing plate, one in which the light absorbing material is provided in each film constituting the polarizing plate and another in which the light absorbing material is provided as a separate optical film, will be described in detail with reference to FIG. 7A, FIG. 7B, FIG. 7C, and FIG. 7D and FIG. 8A, FIG. 8B, FIG. 8C, and FIG. 8D, respectively.

FIG. 7A, FIG. 7B, FIG. 7C, and FIG. 7D are views showing a method of fabricating a polarizing plate according to an exemplary embodiment of the present invention.

Referring to FIG. 7A, a container 1 is prepared to be filled with a dye solution 2. The dye solution 2 comprises iodine (I) or dichroic dye. The dye solution 2 is mixed with a light absorbing material 21 in the container 1. The light absorbing material 21 includes a compound represented by the chemical formula of (SO₃M)ₙ, such as the first compound of the chemical formula 1, the second compound of the chemical formula 2, or the third compound of the chemical formula 3, or another compound capable of absorbing light. The compound may be lipophilic. Therefore, if the dye solution 2 includes an organic solvent, the light absorbing material 21 including the lipophilic compound may be easily dissolved in the dye solution 2.

Referring to FIG. 7B, when an optical film 201a is soaked in a mixed solution 2′ including the light absorbing material 21 and the dye solution 2, the optical film 201a includes the light absorbing material 21 therein. The light absorbing material may be present in the mixed solution 2′ at a weight percent of about 10% or less. In the present exemplary embodiment, the optical film 201 may include polyvinyl alcohol, such as that used for the polarizing film.

Referring to FIG. 7C, the optical film 201 is elongated in a predetermined direction to form a polarizing film 201. The light absorbing material 21 is positioned in the polarizing film 201.

Referring to FIG. 7D, a supporting film 202 is attached to both upper and lower surfaces of the polarizing film 201.

According to the above-described method, the process of mixing the light absorbing material 21 and the dye solution 2 is performed in the course of forming the polarizing film 201. As a result, there is no additional process required to form a polarizing film 201 that is provided with the light absorbing material 21. In addition, since the optical film 201 already includes the light absorbing material 21 when the optical film 201 is elongated, most of the light absorbing material 21 may be aligned along the direction corresponding to the absorption axis of the polarizing film 201. Consequently, the light absorbing material 21 in the polarizing film 201 may absorb most of the light leakage adjacent to the direction of the absorption axis.

The above-described method according to the present exemplary embodiment may be applied to allow other films constituting the polarizing plate to have the light absorbing material 21 therein.

FIG. 8A, FIG. 8B, FIG. 8C, and FIG. 8D are views showing a method of fabricating a polarizing plate according to another exemplary embodiment of the present invention.

Referring to FIG. 8A, a polarizing film 201 is formed by an elongation process.

Referring to FIG. 8B, an optical film including a light absorbing material 21 therein is prepared and attached to the polarizing film 201 to form a light absorbing layer 20 on the polarizing film 201.

Referring to FIG. 8C, a rubbing process is performed on the light absorbing layer 20. In the rubbing process, a roller whose a surface is covered by a rubbing cloth rolls on a surface of the light absorbing layer 20 along the direction in which the polarizing film 201 is elongated, so the light absorbing material 21 may be aligned along the direction in which the polarizing film 201 is elongated. Thus, the light absorbing material 21 may absorb most of the light leakage adjacent to the direction of the absorption axis. There are many alternative physical or chemical methods, other than the rubbing process, that may allow the light absorbing material 21 to be aligned in a desired direction.

Referring to FIG. 8D, a supporting film 202 including two films is attached to the polarizing film 201 and the light absorbing layer 20 such that the two films are attached to the upper surface of the light absorbing layer 20 and the lower surface of the polarizing film 201.

The above-described method, according to the present exemplary embodiment, may be applied to forming other polarizing plates in which the light absorbing material 21 is formed on the supporting film 202 attached to both upper and lower surfaces of the polarizing film 201.

According to the liquid crystal display of the above-described exemplary embodiments, the liquid crystal display may display high quality images and prevent malfunctioning due to static electricity.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A polarizing plate, comprising:
a polarizing film comprising a polarizing material to polarize a light; and
a supporting film arranged on at least one of an upper surface and a lower surface of the polarizing film,
wherein at least one of the polarizing film and the supporting film comprises a light absorbing material to partially absorb the light polarized by the polarizing film, the absorbed light having a wavelength corresponding to visible light.

2. The polarizing plate of claim 1, wherein the light absorbing material is inside the at least one of the polarizing film and the supporting film.

3. The polarizing plate of claim 1, wherein the polarizing film comprises:
a polarizing layer comprising the polarizing material; and
a light absorbing layer comprising the light absorbing material.

4. The polarizing plate of claim 1, wherein the supporting film comprises:
a supporting layer to support the polarizing film; and
a light absorbing layer comprising the light absorbing material.

5. The polarizing plate of claim 1, wherein the light absorbing material comprises a plurality of dyes, and each dye absorbs a wavelength of light that is different from the other dyes.

6. The polarizing plate of claim 5, wherein the light absorbing material comprises:
a first light absorbing material to absorb red light;
a second light absorbing material to absorb green light; and
a third light absorbing material to absorb blue light.

7. The polarizing plate of claim 1, wherein the light absorbing material comprises a black conductor.

8. The polarizing plate of claim 7, wherein the black conductor comprises at least one of carbon black, carbon nanotubes, and fullerene.

9. The polarizing plate of claim 7, wherein the black conductor comprises at least one of polythiophene, polypyrrole, and polyethylenedioxythiophene.

10. A method of fabricating a polarizing plate, the method comprising:
elongating an optical film to form a polarizing film that polarizes light in a direction substantially perpendicular to the direction in which the optical film is elongated; and
forming a supporting film on at least one of an upper surface and a lower surface of the polarizing film,
wherein at least one of the polarizing film and the supporting film comprises a light absorbing material that partially absorbs light polarized in the polarizing film, the absorbed light having a wavelength corresponding to visible light.

11. The method of claim 10, wherein the light absorbing material is inside at least one of the polarizing film and the supporting film.

12. The method of claim 11, wherein the polarizing film is formed by:
mixing the light absorbing material with a dye solution comprising iodine;
soaking the optical film comprising polyvinyl alcohol in the mixed solution; and
elongating the optical film soaked in the mixed solution.

13. The method of claim 12, wherein the mixed solution comprises the light absorbing material at a weight percent of about 10% or less.

14. The method of claim 12, wherein the light absorbing material is lipophilic.

15. The method of claim 10, wherein the polarizing film comprises:
a polarizing layer; and
a light absorbing layer comprising the light absorbing material.

16. The method of claim 15, wherein the polarizing film is formed by:
elongating the optical film to form the polarizing layer;
forming the light absorbing layer comprising the light absorbing material on the polarizing layer; and
rubbing the light absorbing layer in a direction substantially parallel to the direction in which the optical film is elongated.

17. The method of claim 10, wherein the supporting film comprises:
a supporting layer to support the polarizing film; and
a light absorbing layer comprising the light absorbing material.

18. The method of claim 17, wherein the supporting film is formed by:
forming the supporting layer that supports the polarizing film;
forming the light absorbing layer having the light absorbing material; and
rubbing the light absorbing layer in a direction substantially parallel to the direction in which the optical film is elongated.

19. A liquid crystal display, comprising:
a liquid crystal panel comprising a first substrate and a second substrate facing each other and a liquid crystal layer interposed between the first substrate and the second substrate;
a polarizing plate attached to the liquid crystal panel to polarize light; and
an adhesive layer interposed between the liquid crystal panel and the polarizing plate to attach the polarizing plate to the liquid crystal panel,
wherein the polarizing plate comprises a first polarizing plate attached to the first substrate and a second polarizing plate attached to the second substrate, and at least one of the adhesive layer, the first polarizing plate, and the second polarizing plate comprises a light absorbing material that partially absorbs light polarized by the polarizing plate, the absorbed light having a wavelength corresponding to visible light.

20. The liquid crystal display of claim 19, wherein the liquid crystal panel further comprises a pixel electrode formed on the first substrate and a common electrode formed on the second substrate, and the second polarizing plate comprises the light absorbing material.

21. The liquid crystal display of claim 20, wherein the second polarizing plate further comprises a surface treatment film outwardly exposed, and the surface treatment film comprises the light absorbing material.

22. The liquid crystal display of claim 21, wherein the surface treatment film comprises an anti-static property or an anti-glare property.

23. The liquid crystal display of claim 19, wherein the polarizing plate comprises:
a polarizing film comprising a polarizing material to polarize the light; and
a supporting film arranged on at least one of an upper surface and a lower surface of the polarizing film, at least one of the polarizing film and the supporting film comprising the light absorbing material.

24. The liquid crystal display of claim 23, wherein the light absorbing material is inside at least one of the polarizing film and the supporting film.

25. The liquid crystal display of claim 23, wherein the polarizing film comprises:
a polarizing layer comprising the polarizing material; and
a light absorbing layer comprising the light absorbing material.

26. The liquid crystal display of claim 23, wherein the supporting film comprises:
a supporting layer to support the polarizing film; and
a light absorbing layer comprising the light absorbing material.

27. The liquid crystal display of claim 19, wherein the light absorbing material comprises a plurality of dyes, and each dye absorbs a wavelength of light that is different from the other dyes.

28. The liquid crystal display of claim 27, wherein the light absorbing material comprises:
a first light absorbing material to absorb red light;
a second light absorbing material to absorb green light; and
a third light absorbing material to absorb blue light.

29. The liquid crystal display of claim 19, wherein the light absorbing material comprises a black conductor.

30. The liquid crystal display of claim 29, wherein the black conductor comprises at least one of carbon black, carbon nanotubes, and fullerene.

31. The liquid crystal display of claim 29, wherein the black conductor comprises at least one of polythiophene, polypyrrole, and polyethylenedioxythiophene.
